(19) United States
(12) Patent Application Publication
(10) Pub. No.: US 2025/0376115 A1
(43) Pub. Date: Dec. 11, 2025

(54) FOLDING STRUCTURE OF A MIRROR

(71) Applicants: Hyundai Motor Company, Seoul (KR); Kia Corporation, Seoul (KR); SL Mirrortech Corporation, Siheung-si (KR)

(72) Inventors: Geon Jin Kim, Hwaseong-si (KR); Young Hei Kim, Siheung Si (KR); Yong Hwan Kim, Siheung-Si (KR); Yeong Kook Cho, Siheung-Si (KR)

(21) Appl. No.: 18/952,221

(22) Filed: Nov. 19, 2024

(30) Foreign Application Priority Data
Jun. 10, 2024 (KR) 10-2024-0074802

(51) Int. Cl. B60R 1/00

(52) U.S. Cl. CPC B60R 1/006

(57) ABSTRACT

A folding structure of an outside mirror includes a cover, a motor unit located in the cover, and a shaft unit coupled to the motor unit. The shaft unit may receive driving force from the motor unit and rotate the cover with respect to a base. The shaft includes a detent ring coupled to the cover, and the detent ring supports a load generated as the cover moves upward and downward.

### CROSS-REFERENCE TO RELATED APPLICATION

This application claims under 35 U.S.C. § 119(a) the benefit of priority to Korean Patent Application No. 10-2024-0074802 filed on Jun. 10, 2024, the entire contents of which are incorporated herein by reference.

### TECHNICAL FIELD

The present disclosure relates to a folding structure of an outside mirror. More particularly, it relates to a folding structure of an outside mirror in which the mirror allowing a driver to check lane changes and rear obstacles is folded downward in the parked state of a vehicle and is unfolded upward in the driving state of the vehicle, the mirror lifts up by gear engagement to fold and unfold the mirror, and such a lift-up function has the effect of adjusting a mirror gap to prevent airflow noise and friction noise generated as a result.

### BACKGROUND

A vehicle is provided with a rearview mirror installed at the center of the front area of a vehicle interior to enable a driver to detect other vehicles and a driving environment at the rear of the vehicle body. Side mirrors are installed on the left and/or right sides of the front portion of the vehicle body to enable the driver to detect other vehicles and a driving environment at the rear left and rear right sides of the vehicle body.

The side mirrors refer to reflectors installed at the driver's and front passenger's side doors of the front portion of the vehicle. Specifically, the side mirrors are used to detect locations of other vehicles and distances between the driving host vehicle and other vehicles following the host vehicle, so as to allow the host vehicle to change lanes safely, for example, by securing a field of view with respect to a rear situation, and/or facilitate parking by checking whether there are obstacles behind the host vehicle.

However, since the side mirrors of the vehicle have an installation structure which protrudes and extends from the outer surfaces of the driver's and front passenger's side doors, if the vehicle is parked in a parking facility that accommodates a large number of vehicles at the same time, or if the vehicle is parked in a narrow place, such as an alley, the protruding side mirror may come into contact with a parked vehicle next to the host vehicle, or may come into contact with a pedestrian's body or another driving vehicle, and may thus be damaged or broken.

Therefore, recently, a device to automatically unfold and fold a side mirror of a vehicle, for example, a side mirror folding device, has been developed and used as a measure to prevent the side mirror from being damaged or broken by external contact.

Such a folding device may be controlled not only to selectively unfold and fold the side mirror by operating a switch installed on the driver's side, but also to automatically unfold the side mirror when the vehicle is started and automatically fold the side mirror at the same time as the vehicle is turned off.

Such an electric folding structure 10 of a side mirror 20 may include, as shown in FIGS. 1A and 1B, a cover 1 provided in the side mirror 20, a drive motor 2 provided in one side of the cover 1 and having a drive gear 2-a, a shaft 3 provided in the other side of the cover 1, a clutch mechanism 4 having a clutch gear 4-a coupled to the shaft 3, and first and second reduction gears 5 and 6 connecting the drive gear 2-a to the clutch gear 4-a. In the electric folding structure 10 of the side mirror 20, when the drive gear 2 is rotated, the shaft 3 is rotated by transmitting driving force to the drive gear 2-a, the first and second reduction gears 5 and 6, and the clutch gear 4, and the side mirror 20 is rotated to be tilted by rotation of the shaft 3.

This electric folding structure 10 implements rotational movement via gear engagement, but has a problem of not being capable of adjusting a mirror housing upwards and downwards. Also, according to the structure of a conventional mirror for a vehicle (e.g., side mirror), a designated gap is formed between the upper surface of a head provided at the lower end of the axis of the electric folding structure 10 and the lower surface of a base unit. Such a gap causes airflow noise due to friction with air when the vehicle is driven in the extended state of the side mirror, and has problems of requiring manual adjustment of the mirror housing and generating friction noise during operation.

The above information disclosed in this Background section is only for enhancement of understanding of the background of the disclosure and therefore it may contain information that does not form the prior art that is already known in this country to a person of ordinary skill in the art.

### SUMMARY OF THE DISCLOSURE

The following summary presents a simplified summary of certain features. The summary is not an extensive overview and is not intended to identify key or critical elements.

Systems, apparatuses, and methods are described for a folding structure of a mirror. A folding structure of a mirror may comprise a cover, a motor; and a shaft coupled to the motor and configured to, based on a driving force from the motor, rotate the cover with respect to a base. The shaft may comprise a detent ring, coupled to the cover, configured to support a load generated as the cover moves upward or downward based on rotation relative to the base.

Also, or alternatively, a folding structure of a mirror may comprise a motor, a shaft comprising one or more grooves in a first direction parallel to an axis of rotation of the shaft; and a cover, around and concentric with the shaft, comprising one or more first protrusions inserted into one or more grooves. The shaft may be configured to rotate, via the motor and relative to a base of the mirror, to cause the mirror to be in a folded state or an unfolded state. Sides of the one or more grooves may be inclined from the first direction and a second direction parallel to a circumference of the shaft. The one or more first protrusions may be inserted into the one or more grooves in the unfolded state, and when the shaft rotates from the unfolded state to the folded state, the one or more first protrusions move along the sides of the one or more grooves in a direction which raises the cover relative to the base.

These and other features and advantages are described in greater detail below.

### BRIEF DESCRIPTION OF THE DRAWINGS

The above and other features of the present disclosure will now be described in detail with reference to certain examples thereof illustrated in the accompanying drawings which are given hereinbelow by way of illustration only, and thus are not limitative of the present disclosure, and wherein:

FIG. 1A is a view showing a conventional side mirror;

FIG. 1B is a perspective view showing an electric folding structure of the conventional side mirror;

FIG. 2A is a perspective view of an outside mirror assembly according to one example of the present disclosure;

FIG. 2B is a view showing a fastening structure between a motor unit and a shaft unit according to one example of the present disclosure;

FIG. 2C is an exploded perspective view showing the configurations of the motor unit and the shaft unit according to one example of the present disclosure;

FIG. 3A is a view showing a fastening relationship between first protrusions of a cover and stepped portions and inclined portions of the shaft unit in an unfolded state of an outside mirror according to the present disclosure;

FIG. 3B is a cross-sectional view showing an overlapping state between a mirror housing and a cutline seal in the unfolded state of the outside mirror according to the present disclosure;

FIG. 3C is a cross-sectional view showing a coupling relationship between the shaft unit and a detent ring in the unfolded state of the outside mirror according to the present disclosure;

FIG. 4A is a view showing a fastening relationship between the first protrusions of the cover and the stepped portions and the inclined portions of the shaft unit in a folded state of the outside mirror according to the present disclosure;

FIG. 4B is a cross-sectional view showing the mirror housing and the cutline seal spaced apart from each other in the folded state of the outside mirror according to the present disclosure;

FIG. 4C is a cross-sectional view showing a coupling relationship between the shaft unit and the detent ring in the unfolded state of the outside mirror according to the present disclosure;

FIG. 5A is an enlarged view showing a coupled state of a driven gear to the shaft unit according to one example of the present disclosure; and

FIG. 5B is a view showing the configuration of the detent ring according to one example of the present disclosure.

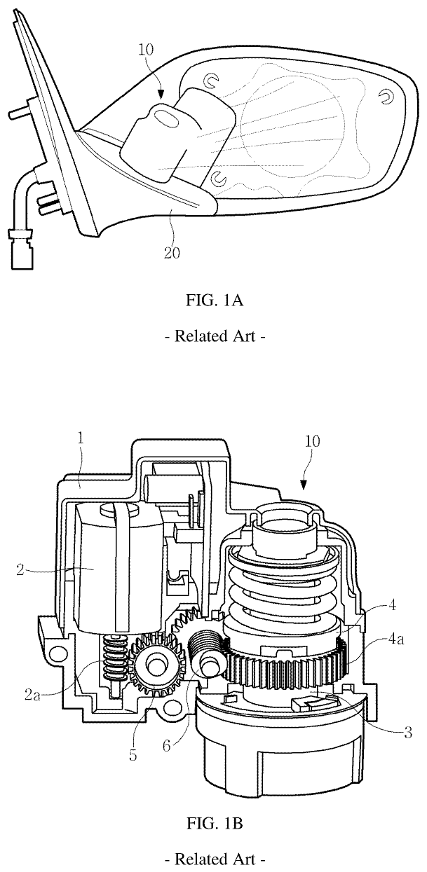

It should be understood that the appended drawings are not necessarily to scale, presenting a somewhat simplified representation of various features illustrative of the basic principles of the disclosure. The specific design features of the present disclosure as disclosed herein, including, for example, specific dimensions, orientations, locations, and shapes, will be determined in part by the particular intended application and use environment.

In the figures, reference numbers refer to the same or equivalent parts of the present disclosure throughout the several figures of the drawing.

### DETAILED DESCRIPTION

Hereinafter, reference will be made in detail to various examples of the present disclosure, examples of which are illustrated in the accompanying drawings and described below. The present disclosure is not limited to the following examples, and the examples may be implemented in various different forms. The examples are provided to make the description of the present disclosure thorough and to fully convey the scope of the present disclosure to those skilled in the art.

Further, in the following description of the examples, it will be understood that the suffixes “part”, “unit”, “module”, etc. indicate units/elements for processing at least one function or operation, and may be implemented as software, hardware, or a combination of software and hardware.

Further, the terminology used herein is for the purpose of describing particular examples only and is not intended to be limiting. As used herein, singular expressions may be intended to include plural expressions as well, unless the context clearly indicates otherwise.

In the description and the claims of the disclosure, directions, such as up (upward), down (downward), left and right (sideward), front (frontward), rear (rearward), etc., are not intended to be limiting to a particular orientation, and are determined based on relative positions of components or in the drawings for convenience of explanation. The directions described herein is based on this, unless specifically limited otherwise.

Hereinafter, the examples will be described in detail with reference to the accompanying drawings. In the description with reference to the accompanying drawings, identical or corresponding components will be indicated by the same reference numerals, and a redundant description thereof will be omitted.

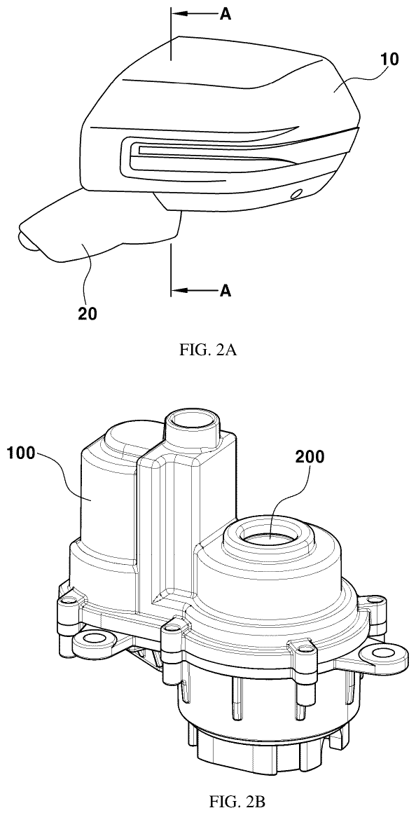

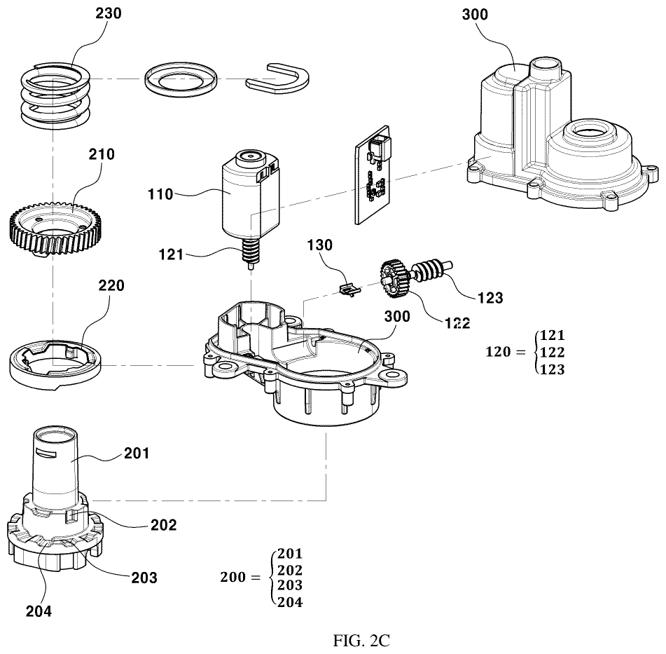

FIG. 2A is a perspective view of an outside mirror assembly according to one example of the present disclosure, FIG. 2B is a view showing a fastening structure between a motor unit 100 (e.g., motor) and a shaft unit 200 (e.g., shaft) according to one example of the present disclosure, and FIG. 2C is an exploded perspective view showing the configurations of the motor unit 100 and the shaft unit 200 according to one example of the present disclosure.

The present disclosure relates to a folding structure of an outside mirror 1, and the outside mirror 1, which is rotatable relative to a base unit 20 (e.g., a base), provides a technology to raise a mirror housing 10 in the height direction (e.g., in a direction, alternatively referred to as a first direction, parallel to the rotational axis of the mirror).

The outside mirror 1 may be configured such that the mirror housing 10 is rotated so that a cover 300 and the mirror housing 10 are integrally rotated with respect to the base unit 20 fixed to a vehicle body, and are folded and unfolded. For example, the cover 300 and the mirror housing 10 may be rotated integrally about line A-A shown in FIG. 2A, and the mirror housing 10 may be rotated about the shift unit 200 located/positioned/configured to be fixed to the base unit 20 in response to the driving force of the motor unit 100 installed in the cover 300.

The outside mirror 1 may be configured such that the cover 300 and the mirror housing 10 are integrally rotated/rotatable. The mirror housing 10 may be prepared to be rotated about the shift unit 200 located/positioned/configured to be fixed to the base unit 20 in response to the driving force of the motor unit 100 installed in the cover 300.

The cover 300, according to one example of the present disclosure, may be fixedly located inside the mirror housing 10 to integrally include the motor unit 100 and the shaft unit 200. The motor unit 100 may include a motor 110 fixedly located inside the mirror housing 10, and a transmission unit 120 configured to transmit the driving force of the motor 110 to the shaft unit 200. The transmission unit 120 may receive driving force from the motor 110 when the motor 110 is operated (e.g., based on an operation of the motor 110). The transmission unit 120 may include a first worm gear 121 configured to and formed on a rotating shaft of the motor 110, a first worm wheel gear 122 engaged with the first worm gear 121, and a second worm gear 123 located coaxially with the first worm wheel gear 122 and configured to have the same rotational speed as the first worm wheel gear 122.

The second worm gear 123 may be engaged/engageable with a driven gear 210 configured to surround the outer circumferential surface of a shaft 201. The driven gear 210 may be restrained by the shaft 201 so that the motor unit 100 including the second worm gear 123 and the cover 300 are rotated and moved along the driven gear 210.

An elastic member 130 may be located at one end of a rotating shaft of the second worm gear 123 to provide elastic force in the axial direction. One end the elastic member 130 may be coupled to one end of the rotating shaft of the second worm gear 123 where the first worm wheel gear 122 is located, and the other end of the elastic member 130 may be bolted to the cover 300 to be fixed thereto. That is, the elastic member 130 of the present disclosure may be configured to press the rotating shaft of the second worm gear 122 in one direction so that the second worm gear 123 may maintain the position thereof engaged with the driven gear 210.

The transmission unit 120 may regulate the position of the second worm gear 123 engaged with the driven gear 210, and thereby, may regulate the position of the second worm gear 123 even when rotation of the cover 300 or external shock is applied to the inside of the cover 300.

The detent ring 220 may be configured such that vertical guide protrusions 221 may be moved along grooves 303 to have a predetermined gap in the height direction of the shaft 201. Moreover, the driven gear 210 may be coupled to the detent ring 220 so that the driven gear 210 and the detent ring 220 may be mutually restrained by each other. The coupling relationship between the detent ring 220 and the driven gear 210 may be maintained via a pressing member 230.

Also, or alternatively, the detent ring 220 may be located on an inner surface of the cover 300. The driven gear 210 may be located on the detent ring 220. The pressing member 230 may be provided between the upper surface of the driven gear 210 and the inner surface of the upper end of the cover 300. The pressing member 230 provides elastic force to press the driven gear 210 downward in the height direction. Therefore, if the cover 300 rises, the pressing member 230 provides elastic force in the height direction to the driven gear 210 and the detent ring 220 so that the detent ring 220 and the driven gear 210 are moved integrally with the cover 30 along the shaft 201.

The driven gear 210 may include position regulation protrusions 211 protruding from one surface thereof facing the detent ring 220. The detent ring 220 may include position regulation recesses 222 into which the position regulation protrusions 211 of the driven gear 210 may be inserted. Accordingly, the detent ring 220 and the driven gear 210 may be integrally restrained by the shaft 201 so that rotation of the detent ring 220 and the driven gear 210 are restricted by inserting the position regulation protrusions 211 into the position regulation recesses 222.

Also, or alternatively, since the elastic force of the pressing member 230 may be applied to the driven gear 210, the driven gear 210 and the detent ring 220 may be integrally moved when they are moved in the height direction of the shaft 210. Further, since the vertical guide protrusions 221 of the detent ring 220 are restrained by the shaft 201 and thus rotation of the detent ring 220 with respect to the shaft 201 is restricted, rotation of the driven gear 20 engaged with the detent ring 220 may be restricted by the shaft 201. As an example, when the cover 300 is raised or lowered, the driven gear 210 and the detent ring 220 may be integrally moved in the height direction with respect to the shaft 201 by the elastic force of the pressing member 230. The vertical guide protrusions 221 of the detent ring 220 may be inserted into the recesses 202 formed in the surface of the shaft 201 so that rotation of the detent ring 220 and the driven gear 210 is restricted by the shaft 201.

Accordingly, even if the driving force of the motor unit 100 is applied to the driven gear 210, the driven gear 210 may be fixed to the shaft 210 by/via the detent ring 220, and the second worm gear 123 may be rotated integrally with the cover 300 along the outer circumferential surface of the driven gear 210.

If the driving force of the motor unit 100 is applied to the shaft unit 200, first protrusions 310 of the cover 300 coupled to the central axis of the shaft unit 200 may be rotated along one or more grooves of the shaft unit 200 each comprising a stepped portion 204 and inclined portions 203.

The first protrusions 310 of the cover 300 of the present disclosure may be rotated along the stepped portions 204 and the inclined portions 203 of the shaft 201 in response to (e.g., based on, according to) the driving force of the motor 110. The first protrusions 310 may be moved in the height direction from the stepped portions 204 to the inclined portions 203. For example, the cover 300, located inside the mirror housing 10, may be coupled to the base unit 20.

In one example, if the outside mirror 1 is switched to the folded state, the cover 300 may be configured such that the first protrusions 310 rise along the inclined portions 203 of the shaft unit 200, thereby providing the effect of preventing friction noise between a cutline seal 21 of the base unit 20 and the mirror housing 10.

On the contrary, in the unfolded state of the outside mirror 1, the first protrusions 310 of the cover 300 may be inserted into the stepped portions 204, and thus, the height of the cover 300 is relatively reduced. Accordingly, the cover 300 may be moved to a height where the mirror housing 10 and the cutline seal 21 interfere with each other, thus providing the effect of reducing airflow noise generated in the gap between the mirror housing 10 and the base unit 20.

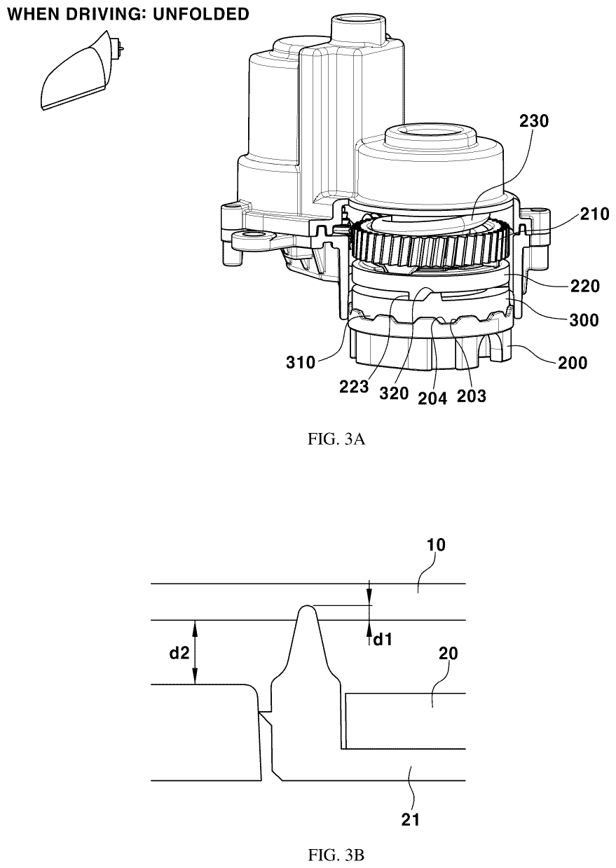

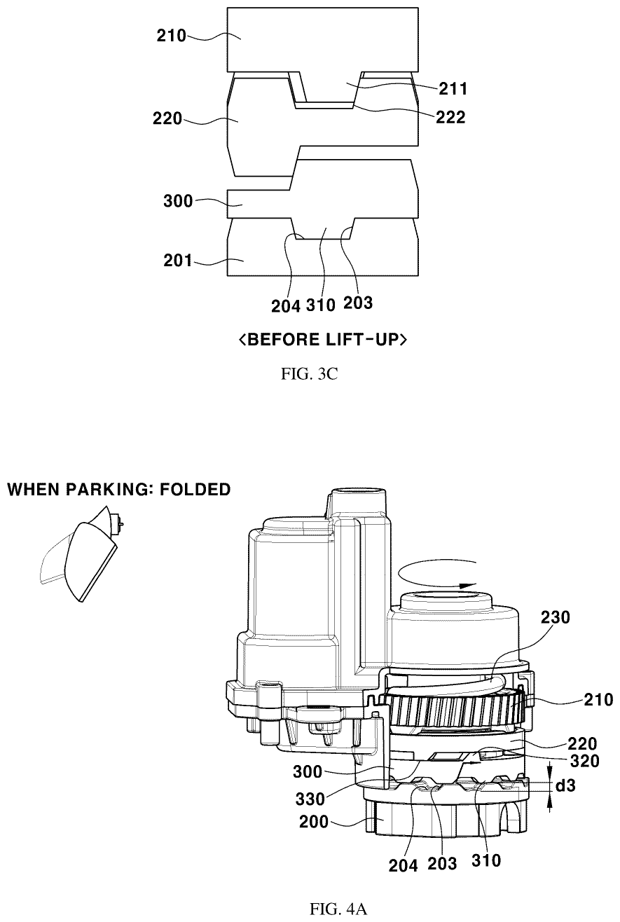

Referring to FIG. 3A, specifically, the cover 300 of the present disclosure may include the first protrusions 310 and second protrusions 320. The first protrusions 310 may have one surface (e.g., a first surface, a convex surface) which is convex toward the stepped portions 204 and the inclined portions 203 of the shaft unit 200 to pass through the stepped portions 204 and the inclined portions 203 of the shaft unit 200. In this case, at least one first protrusion 310 may be provided to be rotated while/to repeatedly passing through the stepped portions 204 and the inclined portions 203 of the shaft unit 200. Further, the second protrusions 320 of the cover 300 of the present disclosure have one surface that may be convex toward the detent ring 220 so that the cover 300 is rotated about the shaft 201.

The shaft unit 200 according to one example of the present disclosure may include the shaft 201 configured to form the central (e.g., rotation) axis. The stepped portions 204 and the inclined portions 203 may be configured to implement vertical movement (e.g., along the direction of the central/rotation axis) and/or restraint. The shaft 201 of the present disclosure includes three parts divided from each other using at least one step as a border in the height direction, i.e., a high part, a middle part, and a low part, and the diameter of the shaft 201 increases from the high part to the low part. Further, the stepped portions 204 of the shaft unit 200 may be provided in the form of a recess, and the inclined portions 203 may be provided in the form of a diagonal line from the stepped portions 203. The stepped portions 204 and the inclined portions 203 of the shaft unit 200 may be provided as portions through which the first protrusions 310 pass (e.g., slide into the stepped portion 204 and out of up the inclined portions 203). The stepped portions 204 and the inclined portions 203 of the shaft unit 200 of the present disclosure may be arranged alternately, and the inclined portions 203 may be provided at a designated angle in the rotation direction of the first protrusions 310 of the cover 300 so that the first protrusions 310 of the cover 300 may be flexibly rotated along the inclined portions 203.

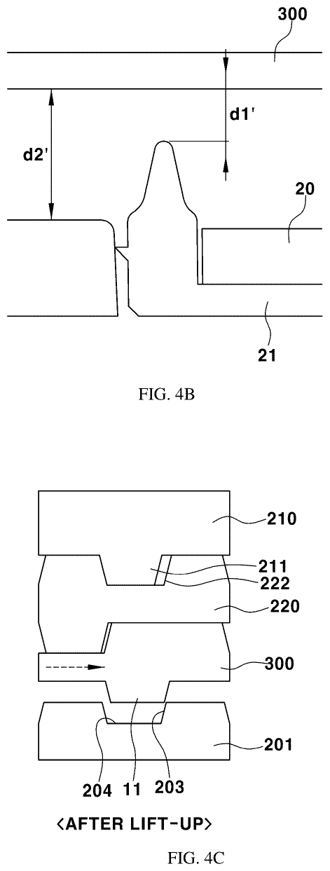

Further, referring to FIG. 4A, a height at which the cover 300 of the present disclosure is lifted up or down may be a vertical height d3 from the stepped portions 204 to the inclined portions 203 of the shaft unit 200.

The recesses 202 may be formed in the outer circumferential surface of the middle part of the shaft 201 of the present disclosure. As described herein, the vertical guide protrusions 221 of the detent ring 220 are inserted into the recesses 202 of the shaft 201 of the shaft unit 200, thereby being capable of restricting rotation of the detent ring 220.

The shaft unit 200 according to one example of the present disclosure may include the pressing member 230 located between the upper surface of the driven gear 210 and the inner surface of the upper end of the cover 300. The pressing member 230 may provide elastic force to press the driven gear 210 downward in the height direction. Accordingly, the pressing member 230 may provide elastic force in the height direction to the driven gear 210 and the detent ring 220 so that the cover 300 may be rotated about the shaft 201.

The driven gear 210 of the shaft unit 200 according to one example of the present disclosure may be coupled to the shaft 201 and have teeth formed along the outer circumferential surface of the driven gear 210. The driven gear 210 may include the position regulation protrusions 211 protruding from one surface of the driven gear 210 facing the detent ring 220. The teeth of the driven gear 210 may be engaged/engageable with the second worm gear 123 to rotate the transmission unit 120.

Since the elastic force of the pressing member is applied to the driven gear 210, the driven gear 210 and the detent ring 220 may be integrally moved when they are moved in the height direction of the shaft 201. Moreover, since the vertical guide protrusions 221 of the detent ring 220 are restrained by the shaft 201 and rotation of the detent ring 220 with respect to the shaft 201 is restricted, rotation of the driven gear 210 fastened to the detent ring 220 may also be restrained by the shaft 201. As an example, when the cover 300 is raised or lowered, the driven gear 210 and the detent ring 220 may be integrally moved in the height direction with respect to the shaft 201 by/via the elastic force of the pressing member 230, and the vertical guide protrusions 221 of the detent ring 220 may be inserted into the recesses 202 formed in the surface of the shaft 201, thereby allowing rotation of the detent ring 220 and the driven gear 210 to be restricted by the shaft 201.

FIG. 3A shows a fastening relationship between the first protrusions 310 of the cover 300 and the stepped portions 204 and the inclined portions 203 of the shaft unit 200 in the unfolded state of the outside mirror 1 according to the present disclosure, and FIG. 3B is a cross-sectional view showing an overlapping state between the mirror housing 10 and the cutline seal 21 in the unfolded state of the outside mirror 1 according to the present disclosure. FIG. 3C is a cross-sectional view showing a coupling relationship between the shaft unit 200 and the detent ring 220 in the unfolded state of the outside mirror 1 according to the present disclosure.

The first protrusions 310 of the cover 300 may be provided to be rotated/rotatable along the stepped portions 204 and the inclined portions 203 of the shaft unit 200 in the unfolded state of the outside mirror 1. The shaft unit 200 may include the driven gear 210 and the detent ring 220 located sequentially on an inner upper surface of the cover 300, and the pressing member 230 located between the upper end of the driven gear 210 and the inner surface of the upper end of the cover 300. The pressing member 230 may apply elastic force to the driven gear 210 toward the lower end of the shaft unit 200.

In the unfolded state of the outside mirror 1, the mirror housing 10 may be located so that the cutline seal 21 located on the base unit 20 and the lower end of the mirror housing 10 interfere with each other. As shown in FIG. 3B, in the unfolded state of the outside mirror 1, the mirror housing 10 and the base unit 20 may be located/positioned/configured to have a gap d2 between the lower end of the mirror housing 10 and the base unit 20, and the upper end of the cutline seal 21 overlaps with the lower surface of the mirror housing 10 by a gap d1.

As shown in FIG. 3C, the driven gear 210 and the detent ring 220, rotation of which is restricted by the shaft 201, may be provided. The pressing member 230 (not shown in FIG. 3C) may provide elastic force to the driven gear 210 in the downward direction of the shaft 201. Further, the position regulation protrusions 211 of the driven gear 210 may remain inserted into the position regulation recesses 222 of the detent ring 220, and the driven gear 210 and the detent ring 220 may be integrally moved in the vertical direction (e.g., up and/or down) of the shaft 201 by/due to the elastic force of the pressing member 230. Also, or alternatively, in the unfolded outside mirror 1, the first protrusions 310 of the cover 300 may be seated on the stepped portions 204 and the inclined portions 203 of the shaft unit 200.

In the unfolded state of the outside mirror 1, the detent ring 220 and the driven gear 210 may be integrally pressed by the pressing member 230. Further, the vertical guide protrusions 221 may be inserted into the recesses 202 so that the cover 300 has a relatively low position.

FIG. 4A is a view showing a fastening relationship between the first protrusions 310 of the cover 300 and the stepped portions 204 and the inclined portions 203 of the shaft unit 200 in the folded state of the outside mirror 1 according to the present disclosure, and FIG. 4B is a cross-sectional view the mirror housing 10 and the cutline seal spaced apart from each other in the folded state of the outside mirror 1 according to the present disclosure. FIG. 4C is a cross-sectional view showing a coupling relationship between the shaft unit 200 and the detent ring 220 after the mirror housing 10 is lifted up in the unfolded state of the outside mirror 1 according to the present disclosure.

If the outside mirror 1 is switched to the folded state, the cover 300 may be rotated through/via/based on the driving force of the motor unit 100. As the cover 300 is rotated, the first protrusions 310 of the cover 300 may be rotated along the stepped portions 204 and the inclined portions 203 of the shaft unit 200, and the cover 300 is raised up to the height of the inclined portions 203 from the stepped portions 204. For example, the driving force of the motor 110 may be transmitted to the first worm gear 121 located coaxially with the motor 110, and may then be transmitted to the first worm wheel gear 122 and the second worm gear 123 located/configured coaxially with the first worm wheel gear 122. The driving force may rotate the second worm gear 123 along the outer circumferential surface of the driven gear 210 located such that rotation thereof may be restricted by the shaft 201. Therefore, if the driving force is applied, the cover 300 may be rotated along the outer circumferential surface of the driven gear 210 restrained by the shaft 201. For example, the driven gear 210 includes guide portions inserted into recesses formed in parallel in the shaft 201, and thereby, the driven gear 210 may be moved in the vertical direction of the shaft 201 in response to movement of the cover 300 in the height direction.

Further, the driven gear 210 includes the position regulation protrusions 211 inserted into the position regulation recesses 222 formed in the detent ring 220. Therefore, the position regulation protrusions 211 may remain inserted into the position regulation recesses 222, and thereby, the driven gear 210 may be located/positioned/configured to be restrained by the detent ring 220. Also, or alternatively, since the vertical guide protrusions 221 of the detent ring 220 are inserted into the recesses 202 of the shaft 201 to restrict rotation of the detent ring 220, the second worm gear 123 is rotated along the outer circumferential surface of the driven gear 210, and the second worm gear 123 is rotated about the shaft 201 integrally with the cover 300. Further, in the folded state of the outside mirror 1, the ends of the recesses of the detent ring 220 and the side surface of the upper end of the over 300 may come into contact with each other.

As shown in FIG. 4B, in the folded state of the outside mirror 1, the mirror housing 10 and the base unit 20 may be located/positioned/configured to have a gap d2′ between the lower end of the mirror housing 10 and the base unit 20, and the upper end of the cutline seal 21 may be separated from the lower surface of the mirror housing 10 by a gap d1′.

As shown in FIG. 4C, when the cover 300 is rotated, the first protrusions 310 and the second protrusions 320 are rotated. For example, when the cover 300 is rotated by the driving force of the motor 110, the first protrusions 310 may be moved while passing through the stepped portions 204 and the inclined portions 203 of the shaft unit 200. Therefore, the cover 300 is moved in the height direction of the stepped portions 204 and the inclined portions 203 in response to the driving force of the motor 110.

The transmission unit 120 may be coupled to the motor 110 and/or located/positioned/configured to apply rotational force to the second worm gear 123 facing the driven gear 210. For example, the transmission unit 120 may be located between the motor unit 100 and the shaft unit 200 of the mirror housing 10. The transmission unit 120 may include the first worm gear 121, located coaxially with the motor 110; the first worm wheel gear 122, located perpendicular to the rotating shaft of the first worm gear 121; and the second worm gear 123, located coaxially with the first worm wheel gear 122 and engaged/engageable with the driven gear 210.

Also, or alternatively, the elastic member 130 may be located at one end of the rotating shaft of the second worm gear 123 to provide elastic force in the axial direction. One end the elastic member 130 is coupled to one end of the rotating shaft of the second worm gear 123 where the first worm wheel gear 122 is located, and the other end of the elastic member 130 is bolted to the cover 300 to be fixed thereto. That is, the elastic member 130 of the present disclosure is configured to press the rotating shaft of the second worm gear 122 in one direction so that the second worm gear 123 may maintain the position thereof engaged with the driven gear 210.

As disclosed herein, the transmission unit 120 may regulate the position of the second worm gear 123 engaged with the driven gear 210, for example, even when rotation of the cover 300 or external shock is applied to the inside of the cover 300.

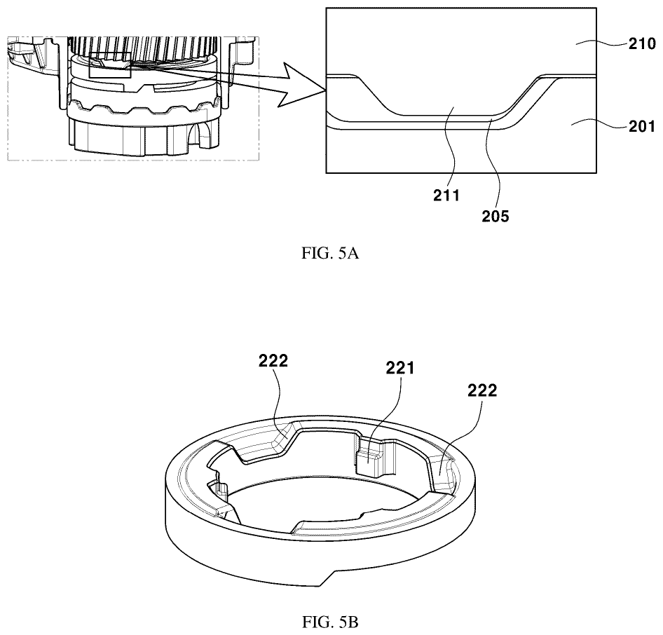

FIG. 5A is an enlarged view showing a coupled state of the driven gear 210 to the shaft 201 according to one example of the present disclosure, and FIG. 5B is a view showing the configuration of the detent ring 220 according to one example of the present disclosure.

The driven gear 210 may face/press against one end of each of shaft recesses 205 due to an external force, for example and may be moved in the height direction of the shaft 201 along an inclined portion formed at the end of each of the shaft recesses 205. Here, once a top of the inclined portion formed at the end of each of the shaft recesses is reached (e.g., the driven gear is elevated out of the shaft recesses 205) the driven gear 210 may be separated from the position regulation recesses 222 formed in the detent ring 220. Therefore, the driven gear 210 separated from the shaft recesses 205 and the position regulation recesses 222 may be freely rotated about the shaft 201.

As shown in FIG. 5B, the detent ring 220 may be restrained so that rotation thereof is restricted with respect to the driven gear 210 and the shaft 201 at the top. For example, the position regulation protrusions 211 of the driven gear 210 may be inserted into the position regulation recesses 222 of the detent ring 220, and the vertical guide protrusions 221 of the detent ring 220 may be inserted into the recesses 202 of the shaft 201, thereby restricting rotation of the detent ring 220 and the driven gear 210 (e.g., relative to each other). Further, the detent ring 220 may further include third protrusions 223, which may form the shape of a recess in the direction of the second protrusions 320 of the cover 300. The second protrusions 320 of the cover 300 may be inserted into the recesses of the detent ring 220 along the circumferences of the recesses, and may be rotated. Further, when the third protrusions 223 of the detent ring 220 come into contact with the side surface of the upper end of the cover 30, the folded state of the mirror housing 10 may be implemented.

Also, or alternatively, both ends of the position regulation recesses 222 facing the position regulation protrusions 211 of the driven gear 210 may include an inclined rib so that the driven gear 210 may be moved in the height direction therealong.

Therefore, when external force greater than or equal to a set value is applied to the cover 300 and rotational force is applied to the driven gear 210, the driven gear 210 may be moved along the inclined rib formed at one end of each of the position regulation recesses 222 of the detent ring 220. Further, each of the position regulation protrusions 211 of the driven gear 210 may be moved in the height direction along the inclined one end of each of the shaft recesses 205, and the driven gear 210 may be separated from the detent ring 220 and the shaft 201 to be rotated.

As such, the present disclosure provides a structure in which, when external force applied to the cover 30 is greater than or equal to a set value, the driven gear 210 is separated from the shaft 201 and is in a rotatable state, thereby providing the effect of preventing damage to the folding structure.

The present disclosure has been made in an effort to solve problems associated with related art, and it is an object of the present disclosure to provide a folding structure of an outside mirror that automatically moves a mirror housing up and down, does not generate friction noise that occurred during manual operation, and reduces airflow noise generated in a designated gap between the upper surface of a head and the lower surface of a base unit.

The objects of the present disclosure are not limited to the above-mentioned objects, and other objects not mentioned herein will be clearly understood by those skilled in the art from the following description and will be more clearly understood from examples of the present disclosure. Further, the objects of the present disclosure may be realized by means and combinations thereof disclosed in the claims.

In one aspect, the present disclosure provides a folding structure of an outside mirror including a cover, a motor unit located in the cover, and a shaft unit coupled to the motor unit to receive driving force from the motor unit and rotate the cover with respect to a base unit, wherein the shaft unit includes a detent ring coupled to the cover, and the detent ring supports a load generated as the cover moves upward and downward.

In an example, the shaft unit may further include at least one stepped portion to implement upward and downward movement of the cover, and inclined portions formed at both ends of the at least one stepped portion.

In another example, the inclined portions of the shaft unit may be formed to be inclined at a predetermined angle in a rotation direction of the cover.

In still another example, the cover may include at least one protrusion configured to protrude in a direction of the inclined portions of the shaft unit, and the at least one protrusion is rotated along the inclined portions and the at least one stepped portion of the shaft unit.

In yet another example, the cover may include second protrusions having one surface convex toward the detent ring and rotated and moved about the shaft.

In still yet another example, the motor unit may include a motor coupled to the cover, and a transmission unit configured to receive driving force from the motor and transmit the driving force to the shaft unit.

In a further example, the transmission unit may include a first worm wheel gear engaged with a first worm gear located on a rotating shaft of the motor, and a second worm gear located coaxially with the first worm wheel gear and coupled to the shaft unit.

In another further example, the shaft unit may further include a shaft coupled to the base unit, the detent ring coupled to the shaft, a driven gear located on the shaft and engaged with the second worm gear, and a pressing member located between the driven gear and the cover.

In still another further example, when driving force from the second worm gear is applied to the driven gear, the driven gear may be restrained by the shaft unit, and rotates the motor unit and the cover about the shaft.

In yet another further example, the folding structure may further include an elastic member located between the second worm gear and the cover to provide elastic force in an axial direction of the second worm gear.

In still yet another further example, the detent ring may include vertical guide protrusions inserted into recesses formed on an outer circumferential surface of the shaft, and position regulation recesses configured such that position regulation protrusions of the driven gear are inserted thereinto.

In a still further example, the position regulation protrusions may be inserted into the position regulation recesses of the detent ring so that the driven gear is restrained by the shaft unit.

In a yet still further example, a mirror housing provided with the cover installed therein may be connected to the base unit, a cutline seal may be provided to come into selective contact with the mirror housing, and the mirror housing may be located/positioned/configured to be spaced apart from the cutline seal if the mirror housing is raised.

In another further example, the detent ring may have third protrusions formed at a lower end thereof, and second protrusions of the cover may be inserted into the third protrusions and rotated.

In still another further example, when the third protrusions come into contact with a side surface of an upper end of the cover, the mirror housing may be implemented in a folded state.

The present disclosure may obtain at least the following effects through the configuration, combination and usage relations consistent with the above-described examples.

The present disclosure may implement a folding structure of an outside mirror that may decrease or increase a gap between a mirror housing and a base unit in the unfolded or folded state of the outside mirror to prevent airflow noise and friction noise during driving of a vehicle.

Also, or alternatively, the present disclosure allows a driver to avoid manually moving the outside mirror through an operation of moving the mirror housing up and down to promote driver's convenience, and reduces the protruding distance of the mirror through an operation of folding the mirror downward after parking to prevent contact with other vehicles even when parking.

The present disclosure described as above is not limited by the examples described herein and accompanying drawings. It should be apparent to those skilled in the art that various substitutions, changes and modifications which are not exemplified herein but are still within the spirit and scope of the present disclosure may be made.

Therefore, the scope of the present disclosure is defined not by the detailed description of the above-described examples, but by the claims and their equivalents, and all variations within the scope of the claims and their equivalents are to be construed as being included in the present disclosure.

What is claimed is:

1. A folding structure of a mirror comprising:
a cover;
a motor; and
a shaft coupled to the motor and configured to, based on a driving force from the motor, rotate the cover with respect to a base,
wherein the shaft comprises a detent ring, coupled to the cover, configured to support a load generated as the cover moves upward or downward based on rotation relative to the base.

2. The folding structure of claim 1, wherein the shaft further comprises at least one stepped portion configured to implement upward or downward movement of the cover via inclined portions formed at both ends of the at least one stepped portion.

3. The folding structure of claim 2, wherein the inclined portions of the shaft are formed to be inclined at a predetermined angle in a rotation direction of the cover.

4. The folding structure of claim 2, wherein the cover comprises at least one protrusion configured to protrude into the at least one stepped portion of the shaft, wherein the at least one protrusion is configured to move up or down the inclined portions based on rotation of the cover.

5. The folding structure of claim 1, wherein the cover comprises second protrusions each having one surface that is convex toward the detent ring, wherein the cover is coupled to the detent ring via the second protrusions.

6. The folding structure of claim 1, wherein the motor is coupled to the cover, the folding structure further comprising:
a transmission unit configured to transmit the driving force to the shaft.

7. The folding structure of claim 6, wherein the transmission unit comprises:
a first worm wheel gear engaged with a first worm gear located on a rotatable shaft of the motor; and
a second worm gear located coaxially with the first worm wheel gear and coupled to the shaft.

8. The folding structure of claim 7, wherein the shaft is coupled to the base and the detent ring is coupled to the shaft, the folding structure further comprising:
a driven gear located on the shaft and engaged with the second worm gear; and
a pressing member located between the driven gear and the cover.

9. The folding structure of claim 8, wherein the second worm gear is configured to apply a driving force to the driven gear so as to cause the driven gear to:
be restrained by the shaft, and
rotate the motor and the cover about the shaft.

10. The folding structure of claim 7, further comprising an elastic member, located between the second worm gear and the cover, configured to provide elastic force in an axial direction of the second worm gear.

11. The folding structure of claim 8, wherein the detent ring comprises:
vertical guide protrusions inserted into recesses formed on an outer circumferential surface of the shaft; and
position regulation recesses configured to accommodate position regulation protrusions of the driven gear inserted thereinto.

12. The folding structure of claim 11, wherein the driven gear is restrained by the shaft via the position regulation protrusions being inserted into the position regulation recesses of the detent ring.

13. The folding structure of claim 1, wherein the cover is installed in a mirror housing connected to the base, a cutline seal is configured to selectively contact the mirror housing, and the mirror housing is spaced apart from the cutline seal if the cover is raised.

14. The folding structure of claim 11, wherein the detent ring comprises third protrusions protruding towards the cover, and second protrusions of the cover are inserted between the third protrusions.

15. The folding structure of claim 14, wherein, the third protrusions are configured to contact a side surface of an upper end of the cover when the mirror is in a folded state.

16. A folding structure of a mirror comprising:
a motor;
a shaft comprising one or more grooves in a first direction parallel to an axis of rotation of the shaft; and
a cover, around and concentric with the shaft, comprising one or more first protrusions inserted into one or more grooves;
wherein the shaft is configured to rotate, via the motor and relative to a base of the mirror, to cause the mirror to be in a folded state or an unfolded state;
wherein, sides of the one or more grooves are inclined from the first direction and a second direction parallel to a circumference of the shaft; and
wherein the one or more first protrusions are inserted into the one or more grooves in the unfolded state, and when the shaft rotates from the unfolded state to the folded state, the one or more first protrusions move along the sides of the one or more grooves in a direction which raises the cover relative to the base.

17. The folding structure of claim 16, wherein, when the shaft rotates from the folded state to the unfolded state, the one or more first protrusions move along the sides of the one or more grooves in a direction which lowers the cover relative to the base.

18. The folding structure of claim 16, further comprising:
a detent configured to support a load generated as the cover is raised or lowered relative to the base.
